(19) United States
(12) Patent Application Publication
(10) Pub. No.: US 2004/0061709 A1
(43) Pub. Date: Apr. 1, 2004

(54) Method and apparatus for driving plasma display panel

(75) Inventors: Joong Seo Park, Nam-ku (KR); Hyun Mok Yu, Pohang-shi (KR)

Correspondence Address: FLESHNER & KIM, LLP, P.O. BOX 221200, CHANTILLY, VA, 20153, US

(73) Assignee: LG Electronics Inc.

(21) Appl. No.: 10/662,406

(22) Filed: Sep. 16, 2003

(30) Foreign Application Priority Data
Sep. 17, 2002 (KR) P2002-56516
Sep. 17, 2002 (KR) P2002-56515
Sep. 16, 2003 (KR) P2003-63925

(51) Int. Cl. G09G 5/10

(52) U.S. Cl. 345/690

(57) ABSTRACT

A method and apparatus for driving a plasma display panel that is adaptive for improving a picture quality. In the method and apparatus, an ON data for each sub-field is calculated to detect a load of said sub-field. An arrangement of the sub-field is adjusted in accordance with said load of the sub-field.

### BACKGROUND OF THE INVENTION

1. Field of the Invention

This invention relates to a plasma display panel, and more particularly to a method and apparatus for driving a plasma display panel that is adaptive for improving a display quality.

2. Description of the Related Art

Generally, a plasma display panel (PDP) displays a picture by utilizing a visible light emitted from a phosphorus material when an ultraviolet ray generated by a gas discharge excites the phosphorus material. The PDP has an advantage in that it has a thinner thickness and a lighter weight in comparison to the existent cathode ray tube (CRT) and is capable of realizing a high resolution and a large-scale screen.

The PDP includes an upper substrate and a lower substrate that are opposed to each other with having barrier ribs therebetween. The upper substrate includes first and second electrodes provided in a direction crossing the barrier ribs. The lower substrate includes an address electrode provided in a direction parallel to the barrier ribs, and a dielectric layer for covering the address electrode. A discharge cell is positioned at an intersection among the first and second electrodes and the address electrode.

Such a PDP drives one frame, which is divided into various sub-fields having a different emission frequency, so as to express gray levels of a picture. Each sub-field is again divided into a reset period for uniformly causing a discharge, an address period for selecting the discharge cell and a sustain period for realizing the gray levels depending on the discharge frequency. For instance, when it is intended to display a picture of 256 gray levels, a frame interval equal to 1/60 second (i.e. 16.67 msec) is divided into 8 sub-fields. Each of the 8 sub-fields is divided into an address period and a sustain period. Herein, the reset period and the address period of each sub-field are equal every sub-field, whereas the sustain period are increased at a ratio of 2ⁿ (wherein n=0, 1, 2, 3, 4, 5, 6 and 7) at each sub-field. Since each sub-field has a different sustain period, it is able to express a gray scale of a picture.

Referring to FIG. 1, a driving apparatus for the PDP includes first and second inverse gamma adjusters 11A and 11B, a gain adjuster 12, an error diffuser 13, a sub-field mapping unit 14, a memory 15, a data aligner 16 and an average picture level (APL) controller 17.

Each of the first and second inverse gamma adjusters 11A and 11B makes an inverse gamma correction of video data from an input line 10 to thereby linearly convert a brightness value according to a gray level value of the video data.

The gain adjuster 12 amplifies red, green and blue video data corrected by the first inverse gamma adjuster 11A by an effective gain to thereby adjust a gain. Further, the gain adjuster 12 adjusts a gain with respect to the red, green and blue video data inputted from the first inverse gamma adjuster 11A in response to an APL detected by the APL controller 17.

The error diffuser 13 diffuses an error component into adjacent cells with respect to data from the gain adjuster 12 to make a fine adjustment of a brightness value. To this end, the error diffuser 13 diffuses an error component into adjacent cells by dividing the data into a positive number part and a decimal fraction part and then multiplying the decimal fraction part by a Floyd-Steinberg coefficient.

The sub-field mapping unit 14 maps a data from the error diffuser onto a predetermined sub-field pattern to apply the mapped data to the data aligner 16.

The data aligner 16 stores the video data inputted from the sub-field mapping unit 14 to the memory 15 and reads out the data stored in the memory 15 to apply the read data to a data driver of the PDP (not shown). The data driver of the PDP includes integrated circuits (IC's) connected to a plurality of address electrodes provided at the PDP to thereby the data inputted from the data aligner 12 to the address electrodes of the PDP.

The APL controller 17 detects an average brightness per frame of the video data inputted from the second inverse gamma adjuster 11B, that is, an APL to thereby output an information about the number of sustaining pulses corresponding to the detected APL. The APL detected by the APL controller 17 is inputted to the gain adjuster 12 and the information about the number of sustaining pulses is inputted to a timing controller (not shown). The timing controller controls a circuit generating the sustaining pulses in accordance with an information about the number of sustaining pulses applied from the APL controller 17 to thereby adjust the number of sustaining pulses.

However, the conventional method and apparatus for driving the PDP has a problem in that contour noise emerges on a moving picture due to an discontinuity of a light generated while sub-fields having a different brightness weighting value are turned on and off in an alignment of the sub-fields. This contour noise allows a brightness at the contour part recognized by the retina tracing a moving object to be darker or brighter than a brightness of the input data when a moving picture is displayed in a certain sub-field alignment.

However, such a conventional method and apparatus for driving the PDP has a limit in expressing a gray level because it adjusts only a sustaining pulse in accordance with the predetermined sub-field pattern and an average brightness per frame, that is, an APL of the video data. A display quality of the conventional PDP fails to reach a satisfying level due to such a contour noise and a limit in the gray level expression ability.

### SUMMARY OF THE INVENTION

Accordingly, it is an object of the present invention to provide a method and apparatus for driving plasma display panel wherein a gray level expression ability is enhanced and a contour noise is reduced, thereby improving a display quality.

In order to achieve these and other objects of the invention, a driving apparatus for a plasma display panel according to one aspect of the present invention, in which one frame period is time-divided into a plurality of sub-fields each given by a certain weighting value, includes an ON data calculator for each sub-field for calculating an ON data for each sub-field to detect a load of said sub-field; and an adjuster for adjusting an arrangement of said sub-field in accordance with said load of the sub-field.

In the driving apparatus, said weighting value of the sub-field is kept at a predetermined weighing value even after the arrangement of the sub-field was adjusted.

Said adjuster arranges the sub-field in accordance with a sequence of a sub-field having a higher load.

Alternatively, said adjuster arranges the sub-field in accordance with a sequence of a sub-field having a lower load.

A driving apparatus for a plasma display panel according to another aspect of the present invention, in which one frame period is time-divided into a plurality of sub-fields each given by a certain weighting value, includes a gray level detector for detecting a gray level distribution of a data; and an adjuster for adjusting at least one of the number of sustaining pulses and a sub-field arrangement in accordance with a gray level distribution of said data.

In the driving apparatus, said adjuster adjusts both the number of sustaining pulses and a sub-field arrangement in accordance with the gray level distribution of said data.

Said adjuster reduces the number of sustaining pulses when gray levels of said data concentrate on a low gray level.

Alternatively, said adjuster increases the number of sustaining pulses when gray levels of said data concentrate on a high gray level.

A driving apparatus for a plasma display panel according to still another aspect of the present invention, in which one frame period is time-divided into a plurality of sub-fields each given by a certain weighting value, includes a random number generator for optionally generating random numbers; and an adjuster for adjusting at least one of the number of sustaining pulses, a sub-field arrangement and a sub-field alignment in accordance with said random numbers.

A method of driving a plasma display panel according to still another aspect of the present invention, in which one frame period is time-divided into a plurality of sub-fields each given by a certain weighting value, includes the steps of calculating an ON data for each sub-field to detect a load of said sub-field; and adjusting an arrangement of said sub-field in accordance with said load of the sub-field.

In the method, said weighting value of the sub-field is kept at a predetermined weighing value even after the arrangement of the sub-field was adjusted.

Said step of adjusting the arrangement of said sub-field arranges the sub-field in accordance with a sequence of a sub-field having a higher load.

Alternatively, said step of adjusting the arrangement of said sub-field arranges the sub-field in accordance with a sequence of a sub-field having a lower load.

A method of driving a plasma display panel according to still another aspect of the present invention, in which one frame period is time-divided into a plurality of sub-fields each given by a certain weighting value, includes the steps of detecting a gray level distribution of a data; and adjusting at least one of the number of sustaining pulses and a sub-field arrangement in accordance with a gray level distribution of said data.

In the method, said step of adjusting said at least one of the number of sustaining pulses and said sub-field arrangement adjusts both the number of sustaining pulses and a sub-field arrangement in accordance with the gray level distribution of said data.

Said step of adjusting said at least one of the number of sustaining pulses and said sub-field arrangement reduces the number of sustaining pulses when gray levels of said data concentrate on a low gray level.

Alternatively, said step of adjusting said at least one of the number of sustaining pulses and said sub-field arrangement increases the number of sustaining pulses when gray levels of said data concentrate on a high gray level.

A method of driving a plasma display panel according to still another aspect of the present invention, in which one frame period is time-divided into a plurality of sub-fields each given by a certain weighting value, includes the steps of optionally generating random numbers; and adjusting at least one of the number of sustaining pulses, a sub-field arrangement and a sub-field alignment in accordance with said random numbers.

### BRIEF DESCRIPTION OF THE DRAWINGS

These and other objects of the invention will be apparent from the following detailed description of the embodiments of the present invention with reference to the accompanying drawings, in which:

FIG. 1 is a block diagram showing a configuration of a conventional plasma display panel driving apparatus;

FIG. 2 is a block diagram showing a configuration of a plasma display panel driving apparatus according to a first embodiment of the present invention;

FIG. 3 is a graph representing an example of load distribution per sub-field in an input data;

FIG. 4 is a detailed block diagram of the sub-field arrangement adjuster shown in FIG. 2;

FIG. 5A to FIG. 5C are graphs representing sub-fields re-aligned by the sub-field aligners shown in FIG. 4;

FIG. 6 is a block diagram showing a configuration of a plasma display panel driving apparatus according to a second embodiment of the present invention;

FIG. 7A to FIG. 7C are graphs representing gray level distributions of various data;

FIG. 8 is a detailed block diagram of the sub-field alignment selector shown in FIG. 6; and

FIG. 9 is a block diagram showing a configuration of a plasma display panel driving apparatus according to a third embodiment of the present invention.

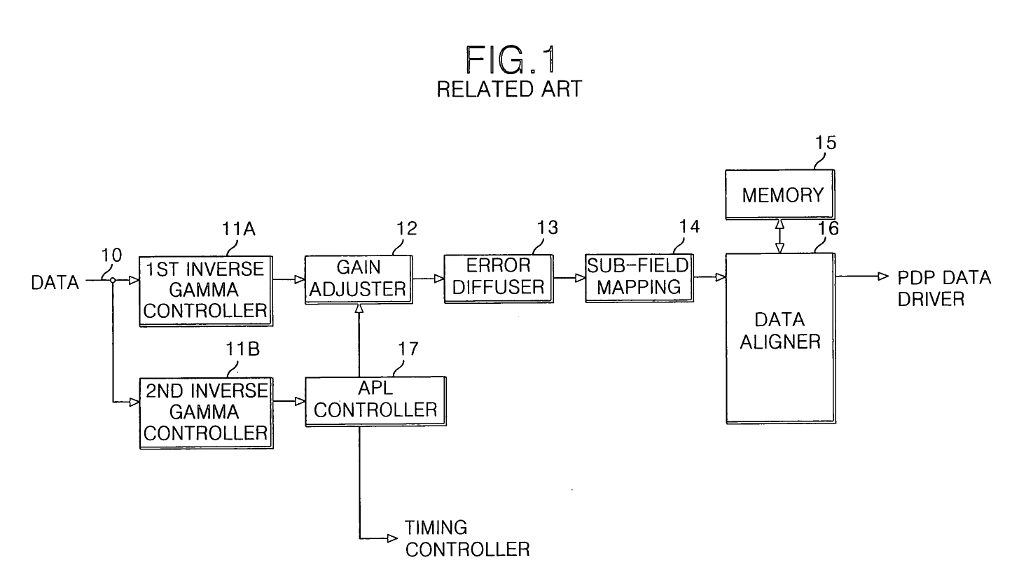

### DETAILED DESCRIPTION OF THE PREFERRED EMBODIMENT

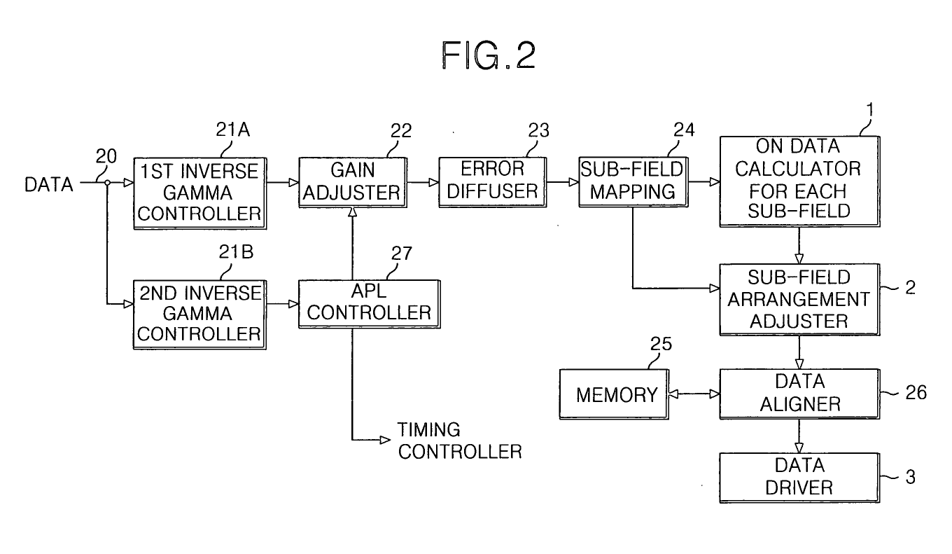

Referring to FIG. 2, a PDP driving apparatus according to a first embodiment of the present invention includes first and second inverse gamma adjusters 21A and 21B, a gain adjuster 22, an error diffuser 23, a sub-field mapping unit 24, a memory 25, a data aligner 26, an average picture level (APL) controller 27, and an ON data calculator 1 for each sub-field and a sub-field arrangement adjuster 2 that are connected between the sub-field mapping unit 24 and the data aligner 26.

Each of the first and second inverse gamma adjusters 21A and 21B makes an inverse gamma correction of video data from an input line 20 to thereby linearly convert a brightness value according to a gray level value of the video data.

The gain adjuster 22 amplifies red, green and blue video data corrected by the first inverse gamma adjuster 21A by an effective gain to thereby adjust a gain. Further, the gain adjuster 22 adjusts a gain with respect to the red, green and blue video data inputted from the first inverse gamma adjuster 21A in response to an APL detected by the APL controller 17.

The error diffuser 23 diffuses an error component into adjacent cells with respect to data from the gain adjuster 22 to make a fine adjustment of a brightness value.

The sub-field mapping unit 24 maps a data from the error diffuser 23 onto a predetermined sub-field pattern to apply the mapped data to the ON data calculator 1 for each sub-field.

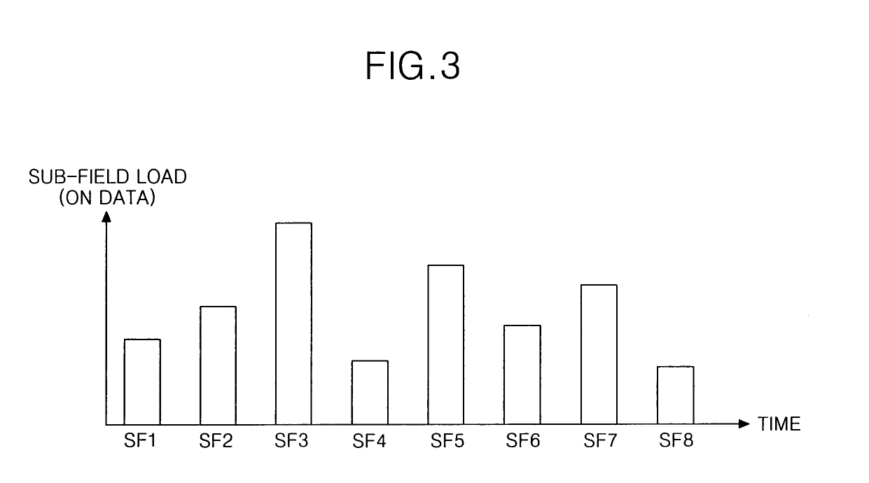

The ON data calculator 1 for each sub-field calculates ON data for each sub-field of data inputted from the sub-field mapping unit 24 to thereby calculates a load for each sub-field. FIG. 3 represents an example of an ON data amount for each sub-field, that is, a load for each sub-field calculated by the ON data calculator 1 for each sub-field.

The sub-field arrangement adjuster 2 re-arranges the sub-fields while keeping a brightness weighting value for each sub-field in accordance with ON data information inputted from the ON data calculator 1 for each sub-field.

The data aligner 26 stores the video data inputted from the sub-field arrangement adjuster 2 to the memory 25 and reads out the data stored in the memory 25 to apply the read data to a data driver 3 of the PDP. The data driver 3 of the PDP includes integrated circuits (IC's) connected to a plurality of address electrodes provided at the PDP to thereby the data inputted from the data aligner 26 to the address electrodes of the PDP.

The APL controller 27 detects an average brightness per frame, that is, an APL of the video data inputted from the second inverse gamma adjuster 21B, to thereby output an information about the number of sustaining pulses corresponding to the detected APL. The APL detected by the APL controller 27 is inputted to the gain adjuster 22, and the information about the number of sustaining pulses is inputted to a timing controller (not shown). The timing controller controls a circuit generating the sustaining pulses in accordance with an information about the number of sustaining pulses applied from the APL controller 27 to thereby adjust the number of sustaining pulses.

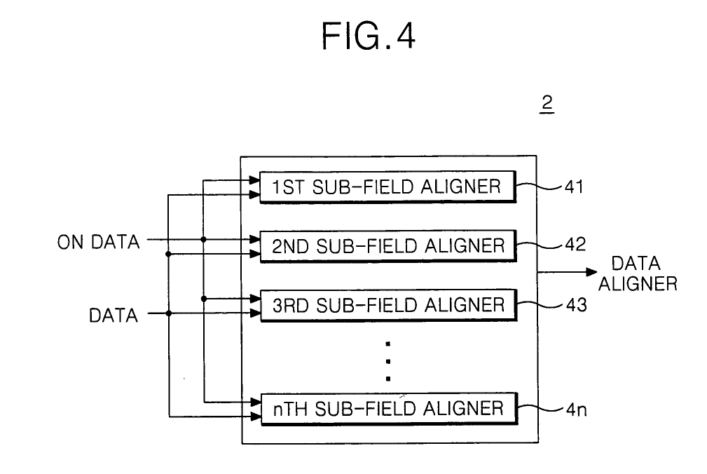

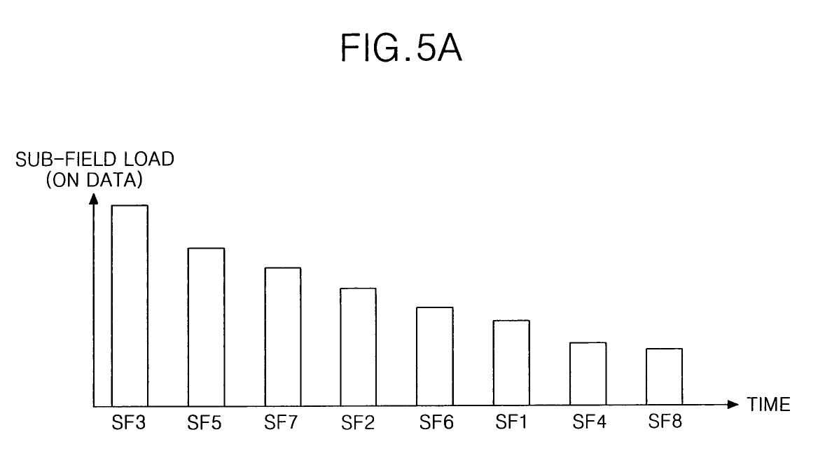

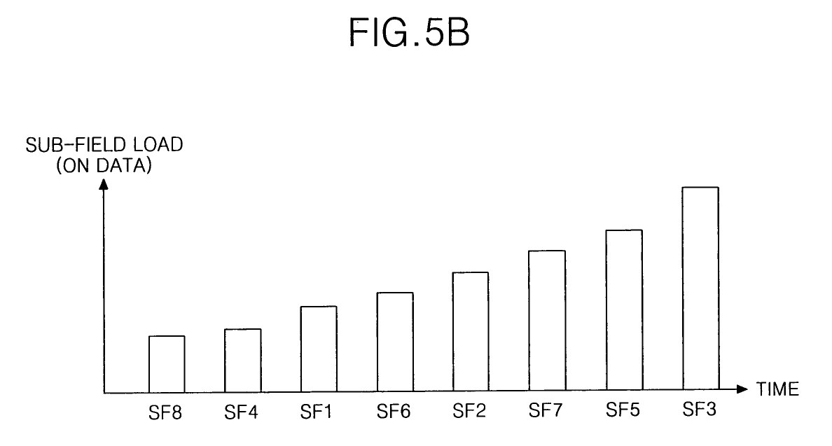

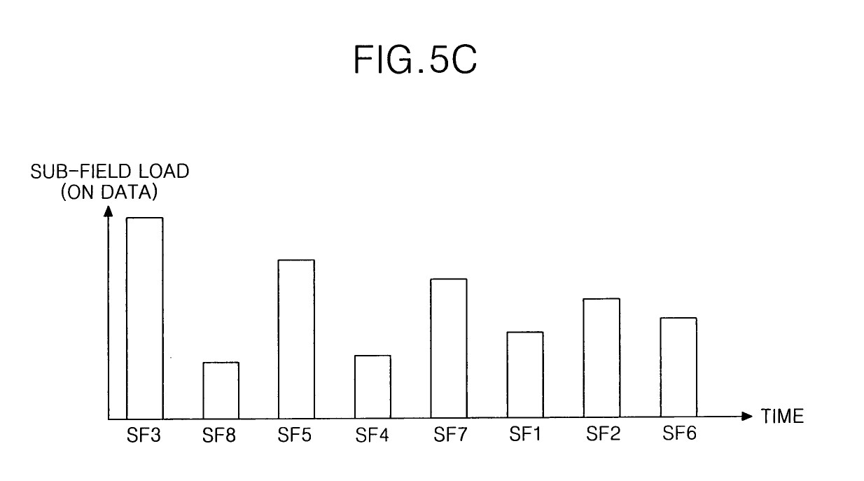

An function and operation of the sub-field arrangement adjuster 2 will be described with reference to FIG. 4 to FIG. 5C below.

Referring to FIG. 4, the sub-field arrangement adjuster 2 includes n sub-field aligners 41 to 4n (wherein, n is an integer) for re-arranging sub-fields under a different reference.

The first sub-field aligner 41 re-arranges the sub-fields in accordance with a sequence having a high sub-field load while keeping a brightness weighting value for each sub-field. If it is assumed that a load for each sub-field calculated by the ON data calculator 1 for each sub-field should be as shown in FIG. 3, then the first sub-field aligner 41 primarily arranges a data for the third sub-field SF3 having the highest load and then arranges the fifth sub-field SF5, the seventh sub-field SF7, the second sub-field SF2, the sixth sub-field SF6, the first sub-field SF1, the fourth sub-field SF4 and the eighth sub-field SF8 in accordance with a sequence having a higher load as shown in FIG. 5A.

The second sub-field aligner 42 re-arranges the sub-fields in accordance with a sequence having a low sub-field load while keeping a brightness weighting value for each sub-field. If it is assumed that a load for each sub-field calculated by the ON data calculator 1 for each sub-field should be as shown in FIG. 3, then the second sub-field aligner 42 primarily arranges a data for the eighth sub-field SF8 having the lowest load and then arranges the fourth sub-field SF4, the first sub-field SF1, the sixth sub-field SF6, the second sub-field SF2, the seventh sub-field SF7, the fifth sub-field SF5 and the third sub-field SF3 in accordance with a sequence having a lower load as shown in FIG. 5B.

The third sub-field aligner 43 re-arranges a portion of sub-fields in accordance with a sequence having a high sub-field load and re-arranges the remaining sub-fields in accordance with a sequence having a low sub-field load while keeping a brightness weighting value for each sub-field. If it is assumed that a load for each sub-field calculated by the ON data calculator 1 for each sub-field should be as shown in FIG. 3, then the third sub-field aligner 43 primarily arranges a data for the third sub-field SF3 having the highest load and then the eighth sub-field SF8 having the lowest load, and thereafter arranges the fifth sub-field SF5, the fourth sub-field SF4, the seventh sub-field SF7, the first sub-field SF1, the second sub-field SF2 and the sixth sub-field SF6.

Output data of the sub-field aligners 41 to 4n may be selected regularly as output data of a specific sub-field aligner or as output data of at least two sub-field aligners arranged periodically or non-periodically. For instance, output data of the first sub-field aligner 41 may be applied to the data aligner 26. Alternatively, output data of the first sub-field aligner 41 may be primarily applied to the data aligner 26 and then output data of the second sub-field aligner 42 may be applied to the data aligner 26.

If the sub-fields are arranged in a sequence having a higher load or a lower load in the above-mentioned manner, then each discharge cell is continuously emitted and hence an emission frequency between the continuous sub-fields does not have a large difference. Accordingly, a contour noise does almost not emerge on a moving picture.

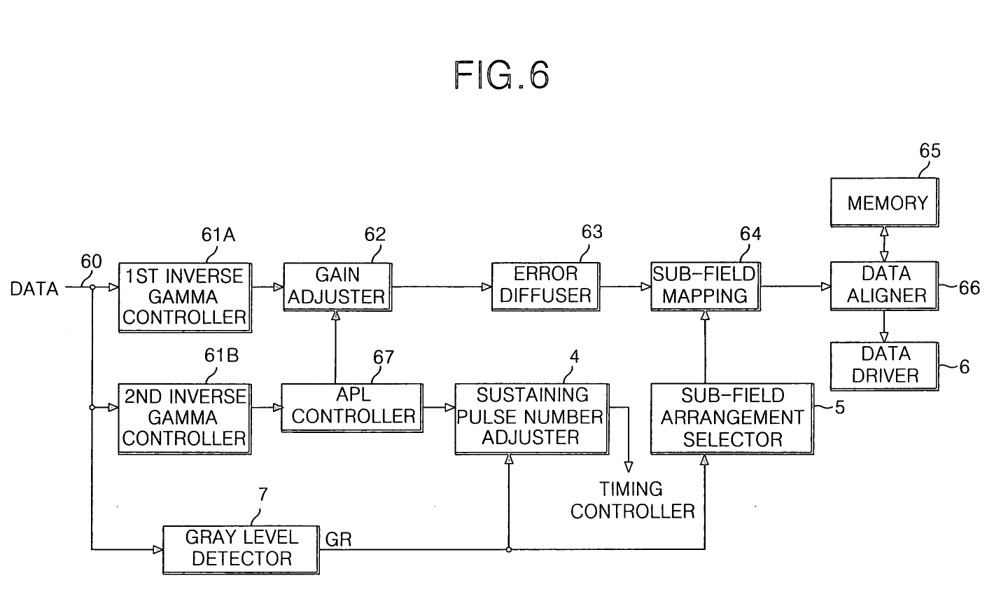

FIG. 6 shows a PDP driving apparatus according to a second embodiment of the present invention.

Referring to FIG. 6, the PDP driving apparatus includes first and second inverse gamma adjusters 61A and 61B, a gain adjuster 62, an error diffuser 63, a sub-field mapping unit 64, a memory 65, a data aligner 66, an average picture level (APL) controller 67, a gray level calculator 7 for detecting a gray level distribution of an input data, a sustaining pulse number adjuster 4 for adjusting the number of sustaining pulses in accordance with the gray level distribution, and a sub-field arrangement selector 5 for selecting a sub-field arrangement in accordance with the gray level distribution.

The first and second inverse gamma adjusters 61A and 61B, the gain adjuster 62 and the error diffuser 63 is substantially identical to those of the above-mentioned first embodiment.

The APL controller 67 detects an average brightness per frame, that is, an APL of the video data inputted from the second inverse gamma adjuster 61B, to thereby output an information about the number of sustaining pulses corresponding to the detected APL. The APL detected by the APL controller 67 is inputted to the gain adjuster 62, and the number of sustaining pulses is inputted to the sustaining pulse number adjuster 4.

The gray level detector 7 obtains the entire distribution, that is, a histogram of each gray level for every one frame with respect to a data from the input line 60. Further, the gray level detector 7 applies the detected gray level distribution to the sustaining pulse number adjuster 4 and the sub-field arrangement selector 5. Alternatively, the gray level detector 7 divides a gray level distribution GR of data into predetermined regions for its detection. For instance, the gray level detector 7 can divide the gray level distribution GR into a first region between 0 through 32, a second region between 33 through 64, a third region between 65 through 96, a fourth region between 97 through 128, a fifth region between 161 through 192, a sixth region between 193 through 224 and a sixth region between 225 through 256 for its detection.

The sustaining pulse number adjuster 4 adjusts the number of sustaining pulses inputted from the APL controller 42 in accordance with the gray level distribution GR. If data having a low gray level are more than data having the other gray levels in the gray level distribution GR, then the sustaining pulse number adjuster 4 reduces the number of sustaining pulses to less than the predetermined reference value to thereby control a dark picture such that it becomes darker. On the other hand, if data having a high gray level are more than data having the other gray levels in the gray level distribution GR, then the sustaining pulse number adjuster 4 increases the number of sustaining pulses to more than the predetermined reference value to thereby control a bright picture such that it becomes brighter.

The sub-field arrangement selector 5 has been stored, in advance, with a sub-field arrangement in which a low gray level expression is emphasized, a sub-field arrangement in which a middle gray level expression is emphasized, a sub-field arrangement in which a high gray level expression is emphasized and a sub-field arrangement on which a contour noise does almost not emerge, etc. The sub-field arrangement selector 5 selects a specific sub-field arrangement from a plurality of predetermined sub-field arrangements in accordance with the gray level distribution GR from the gray level detector 7.

TABLE 1

| | | | | | | | | | |
|---|---|---|---|---|---|---|---|---|---|
| Arrangement 1 | 1 | 2 | 4 | 8 | 16 | 32 | 64 | 128 | |
| Arrangement 2 | 1 | 2 | 4 | 8 | 16 | 128 | 32 | 64 | |
| Arrangement 3 | 1 | 2 | 4 | 8 | 16 | 32 | 64 | 64 | 64 |

If a portion of the sub-field arrangements stored in the sub-field arrangement selector 5 is as the above table and a data having a gray level in which a contour noise may emerge is inputted, then the sub-field selector 5 selects a sub-field arrangement ‘Arrangement 1’ or a sub-field arrangement ‘Arrangement 2’. If a data having a data value changing from 127 into 128 is inputted, then the sub-field arrangement selector 5 selects ‘Arrangement 2’ to reduce a contour noise. Furthermore, if a data having a data value changing from 32 into 64 is inputted, then the sub-field arrangement selector 5 selects ‘Arrangement 3’ to reduce a contour noise.

The sub-field mapping unit 64 maps a data from the error diffuser 63 onto the sub-field arrangement selected by the sub-field arrangement selector 5 to apply the mapped data to the data aligner 66.

The data aligner 66 stores the video data inputted from the sub-field mapping unit 64 to the memory 65 and reads out the data stored in the memory 65 to apply the read data to a data driver 68 of the PDP. The data driver 68 of the PDP includes integrated circuits (IC's) connected to a plurality of address electrodes provided at the PDP to thereby the data inputted from the data aligner 66 to the address electrodes of the PDP.

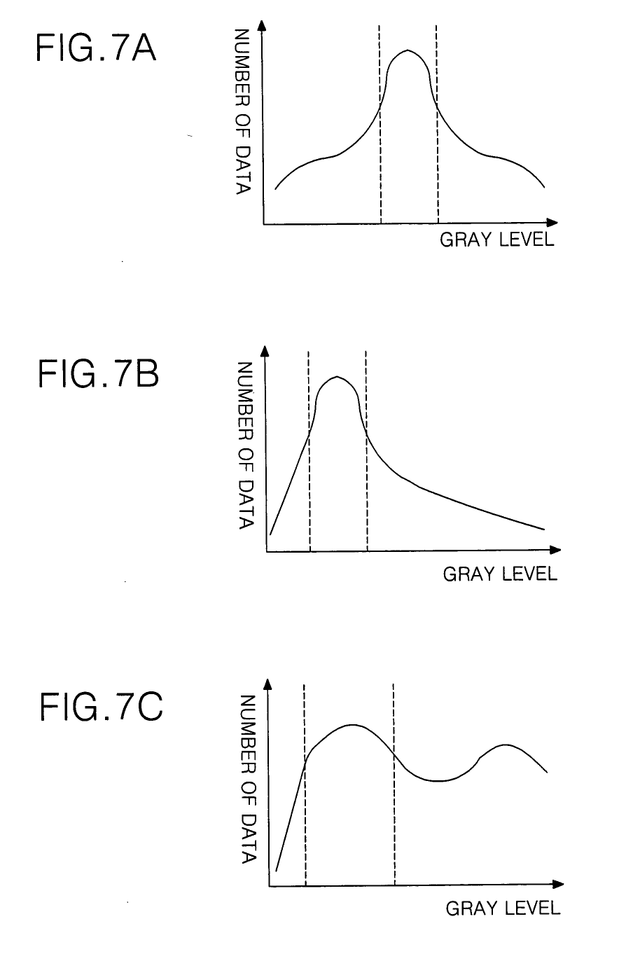

FIG. 7A to FIG. 7C represent examples of gray distribution of an input data.

FIG. 7A illustrates a gray level distribution when there are many data having a middle gray level of data for one frame; FIG. 7B illustrates a gray level distribution when there are many data having a low gray level of data for one frame; and FIG. 7C illustrates a gray level distribution when there are many data having a middle gray level of data for one frame. When such data is inputted, the PDP driving method and apparatus detects a gray level distribution of a data and differentiates the number of sustaining pulses and a sub-field arrangement in accordance with the detected gray level distribution, thereby adjusting the number of sustaining pulse and the sub-field arrangement. Accordingly, it becomes possible to enhance a gray level expression ability and reduce a contour noise.

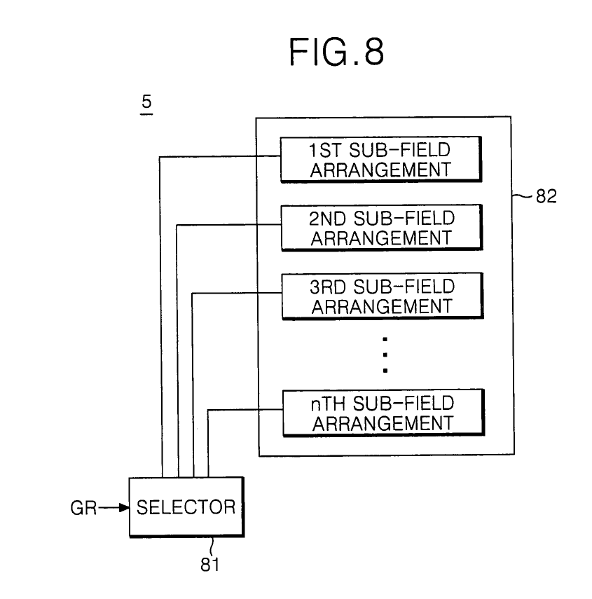

FIG. 8 shows the sub-field arrangement selector 5 in detail.

Referring to FIG. 8, the sub-field arrangement selector 5 includes a memory 82 stored with n sub-field arrangements, and a selector 83 for controlling the memory 82.

The selector 83 selects a specific sub-field arrangement from the n sub-field arrangements stored in the memory 82 in accordance with a gray level distribution from the gray level detector 7. Further, the selector 83 applies the selected sub-field arrangement to the sub-field mapping unit 64.

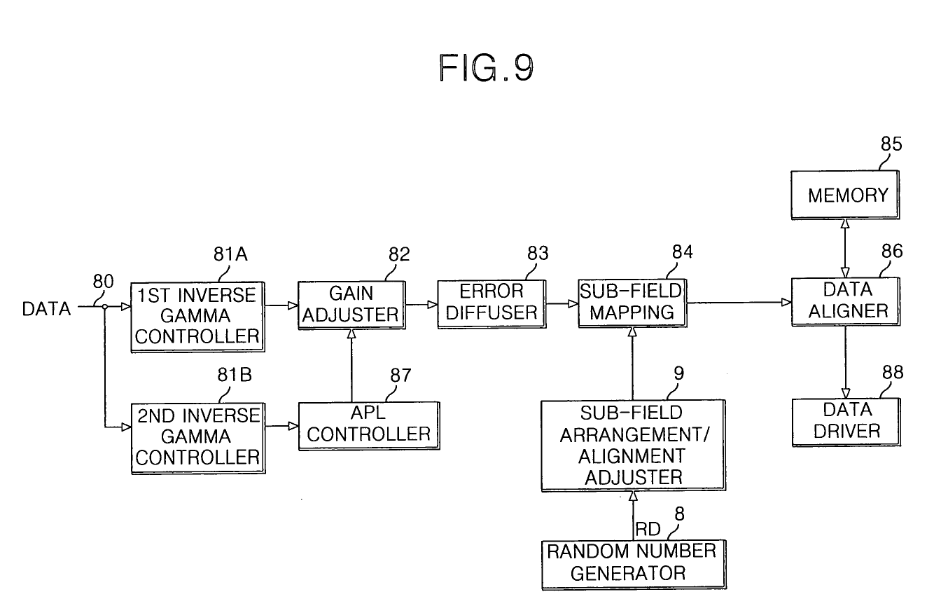

FIG. 9 shows a PDP driving apparatus according to a third embodiment of the present invention.

Referring to FIG. 9, the PDP driving apparatus includes first and second inverse gamma adjusters 81A and 81B, a gain adjuster 82, an error diffuser 83, a sub-field mapping unit 84, a memory 85, a data aligner 86, an average picture level (APL) controller 87, a random number generator 8 for generating random numbers, and a sub-field arrangement/alignment adjuster 9 connected between the random number generator 8 and the sub-field mapping unit 84.

Each of the first and second inverse gamma adjusters 81A and 81B makes an inverse gamma correction of video data from an input line 80 to thereby linearly convert a brightness value according to a gray level value of the video data.

The gain adjuster 82 amplifies red, green and blue video data corrected by the first inverse gamma adjuster 81A by an effective gain to thereby adjust a gain. Further, the gain adjuster 82 adjusts a gain with respect to the red, green and blue video data inputted from the first inverse gamma adjuster 81A in response to an APL detected by the APL controller 87.

The error diffuser 83 diffuses an error component into adjacent cells with respect to data from the gain adjuster 22 to make a fine adjustment of a brightness value.

The sub-field mapping unit 84 maps a data from the error diffuser 83 onto a sub-field pattern selected by the sub-field arrangement/alignment adjuster 9.

The data aligner 86 stores the video data inputted from the sub-field mapping unit 84 to the memory 85 and reads out the data stored in the memory 85 to apply the read data to a data driver 88 of the PDP. The data driver 88 of the PDP includes integrated circuits (IC's) connected to a plurality of address electrodes provided at the PDP to thereby the data inputted from the data aligner 86 to the address electrodes of the PDP.

The APL controller 87 detects an average brightness per frame, that is, an APL of the video data inputted from the second inverse gamma adjuster 81B, to thereby output an information about the number of sustaining pulses corresponding to the detected APL. The APL detected by the APL controller 87 is inputted to the gain adjuster 82, and the information about the number of sustaining pulses is inputted to a timing controller (not shown). The timing controller controls a circuit generating the sustaining pulses in accordance with an information about the number of sustaining pulses applied from the APL controller 87 to thereby adjust the number of sustaining pulses.

The random number generator 8 generates a certain of random numbers RD and applies the random numbers RD to the sub-field arrangement/alignment adjuster 8.

The sub-field arrangement/alignment adjuster 9 is stored with a plurality of sub-field arrangements in which a sub-field arrangement, the number of sub-fields and a weighting value of the sub-fields are different from each other. The sub-field arrangement/alignment adjuster 9 selects a sub-field arrangement corresponding to random numbers RD from the random number generator 8 to apply it to the sub-field mapping unit 84.

As a result, the PDP driving method and apparatus according to the third embodiment of the present invention optionally changes a sub-field arrangement, a weighting value of sub-fields or the number of sub-fields, thereby minimizing a contour noise that may emerge at a certain sub-field arrangement.

As described above, the PDP driving method and apparatus according to the present invention re-arranges a data in accordance with a load sequence of the sub-fields, or differentiates a sub-field arrangement in accordance with a gray level distribution of the data or optionally differentiates a sub-field arrangement. Accordingly, the PDP driving method and apparatus according to the present invention can enhance a gray level expression ability and can minimize a contour noise, thereby improving a display quality.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A driving apparatus for a plasma display panel in which one frame period is time-divided into a plurality of sub-fields each given by a certain weighting value, said driving apparatus comprising:
an ON data calculator for each sub-field for calculating an ON data for each sub-field to detect a load of said sub-field; and
an adjuster for adjusting an arrangement of said sub-field in accordance with said load of the sub-field.

2. The driving apparatus as claimed in claim 1, wherein said weighting value of the sub-field is kept at a predetermined weighing value even after the arrangement of the sub-field was adjusted.

3. The driving apparatus as claimed in claim 1, wherein said adjuster arranges the sub-field in accordance with a sequence of a sub-field having a higher load.

4. The driving apparatus as claimed in claim 1, wherein said adjuster arranges the sub-field in accordance with a sequence of a sub-field having a lower load.

5. A driving apparatus for a plasma display panel in which one frame period is time-divided into a plurality of sub-fields each given by a certain weighting value, said driving apparatus comprising:
a gray level detector for detecting a gray level distribution of a data; and
an adjuster for adjusting at least one of the number of sustaining pulses and a sub-field arrangement in accordance with a gray level distribution of said data.

6. The driving apparatus as claimed in claim 5, wherein said adjuster adjusts both the number of sustaining pulses and a sub-field arrangement in accordance with the gray level distribution of said data.

7. The driving apparatus as claimed in claim 5, wherein said adjuster reduces the number of sustaining pulses when gray levels of said data concentrate on a low gray level.

8. The driving apparatus as claimed in claim 5, wherein said adjuster increases the number of sustaining pulses when gray levels of said data concentrate on a high gray level.

9. A driving apparatus for a plasma display panel in which one frame period is time-divided into a plurality of sub-fields each given by a certain weighting value, said driving apparatus comprising:
a random number generator for optionally generating random numbers; and
an adjuster for adjusting at least one of the number of sustaining pulses, a sub-field arrangement and a sub-field alignment in accordance with said random numbers.

10. A method of driving a plasma display panel in which one frame period is time-divided into a plurality of sub-fields each given by a certain weighting value, said method comprising the steps of:
calculating an ON data for each sub-field to detect a load of said sub-field; and
adjusting an arrangement of said sub-field in accordance with said load of the sub-field.

11. The method as claimed in claim 10, wherein said weighting value of the sub-field is kept at a predetermined weighing value even after the arrangement of the sub-field was adjusted.

12. The method as claimed in claim 10, wherein said step of adjusting the arrangement of said sub-field arranges the sub-field in accordance with a sequence of a sub-field having a higher load.

13. The method as claimed in claim 10, wherein said step of adjusting the arrangement of said sub-field arranges the sub-field in accordance with a sequence of a sub-field having a lower load.

14. A method of driving a plasma display panel in which one frame period is time-divided into a plurality of sub-fields each given by a certain weighting value, said method comprising the steps of:
detecting a gray level distribution of a data; and
adjusting at least one of the number of sustaining pulses and a sub-field arrangement in accordance with a gray level distribution of said data.

15. The method as claimed in claim 14, wherein said step of adjusting said at least one of the number of sustaining pulses and said sub-field arrangement adjusts both the number of sustaining pulses and a sub-field arrangement in accordance with the gray level distribution of said data.

16. The driving apparatus as claimed in claim 14, wherein said step of adjusting said at least one of the number of sustaining pulses and said sub-field arrangement reduces the number of sustaining pulses when gray levels of said data concentrate on a low gray level.

17. The driving apparatus as claimed in claim 14, wherein said step of adjusting said at least one of the number of sustaining pulses and said sub-field arrangement increases the number of sustaining pulses when gray levels of said data concentrate on a high gray level.

18. A method of driving a plasma display panel in which one frame period is time-divided into a plurality of sub-fields each given by a certain weighting value, said method comprising the steps of:
optionally generating random numbers; and
adjusting at least one of the number of sustaining pulses, a sub-field arrangement and a sub-field alignment in accordance with said random numbers.
